(19) United States
(12) Patent Application Publication
(10) Pub. No.: US 2020/0045197 A1
(43) Pub. Date: Feb. 6, 2020

(54) SYSTEM AND METHOD FOR DEPLOYING SOFTWARE AND APPLICATIONS

(71) Applicant: Toshiba TEC Kabushiki Kaisha, Shinagawa-ku (JP)

(72) Inventor: Dehua ZHAO, Irvine, CA (US)

(21) Appl. No.: 16/527,400

(22) Filed: Jul. 31, 2019

Related U.S. Application Data
(60) Provisional application No. 62/712,589, filed on Jul. 31, 2018.

(51) Int. Cl. H04N 1/00; H04L 12/24; H04L 29/08

(52) U.S. Cl. CPC H04N 1/00973; H04L 41/0853; H04L 67/34; H04N 2201/0094; H04N 1/00938; H04N 1/00954; H04L 41/0213; H04L 41/0869

(57) ABSTRACT

A system and method for discovering compatible multifunction peripherals and deploying software and applications across a network includes a memory for storing internet protocol (IP) addresses and software for updating multifunction peripherals, a user interface for entering IP addresses and simple network management protocol (SNMP) configuration data, a network interface for communicating with multifunction peripherals across a network, and a processor. The processor transmits an SNMP Get message to each of the configured IP addresses and receives in response version data from each multifunction peripheral that responds to the SNMP Get query. The processor validates that the software update is compatible with the current version of the multifunction peripheral. The processor transmits the software update only to those multifunction peripherals that are compatible with the software update.

### CROSS-REFERENCE TO RELATED APPLICATIONS

This application claims the benefit of U.S. Provisional Application No. 62/712,589 filed Jul. 31, 2018, which is incorporated herein by reference.

### TECHNICAL FIELD

This application relates generally to deploying software and applications onto multifunction peripherals. The application relates more particularly to discovering compatible multifunction peripherals and automatically deploying software and applications across a network.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

MFPs can have different versions of hardware, firmware, and software that may or may not be compatible with newer software and applications. When new software becomes available, system administrators may need to look up the internet protocol (IP) address of each MFP on the network and then manually check to determine if the MFP is capable of supporting the new software prior to installing it. When there are multiple MFPs on the network that may need to be updated with the new software, it can be time consuming for a system administrator to have to manually check versions for compatibility and update each MFP individually.

### BRIEF DESCRIPTION OF THE DRAWINGS

Various embodiments will become better understood with regard to the following description, appended claims and accompanying drawings wherein:

FIG. 1 is an example embodiment of a system for discovering and deploying software and applications to compatible MFPs across a network;

FIG. 2 is an example embodiment of a multifunction peripheral;

FIG. 3 is an example embodiment of a digital device such as a portable digital device;

FIG. 4 is an example embodiment of software modules for a system for discovering and deploying software and applications to compatible MFPs; and

FIG. 5 is flowchart of example operations of a system for discovering and deploying software and applications to compatible MFPs across a network.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices, methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

When new software becomes available for an MFP, for example a new application that provides new features, system administrators may need to perform certain steps to install the new software on each MFP. The system administrators may need to determine the internet protocol (IP) addresses of MFPs. This information may be stored by a system administrator in a spreadsheet, however if the information is not kept current then some MFPs may not receive the updated software. Additionally, the MFPs may be located in different physical locations and different IP subnets which can make it difficult or time consuming for the system administrators to check each MFP to ensure that the new software is available to users. After determining the IP addresses of each of the MFPs, system administrators may need to manually check each MFP to ensure that the new software can be run with the current software, firmware, and hardware versions on each of the MFPs. For MFPs that can execute the new software, the system administrators typically remotely load the new software onto each of the MFPs. It can be costly and time consuming for system administrators to track and find the IP addresses of all of the MFPs and then manually validate each MFP against the software and hardware requirements of the new software before deployment.

A smart application deployment system and method helps system administrators to quickly discover MFPs that meet the software and hardware requirements of new software and applications and software in a specified network environment and then remotely install new software and applications in a timely manner. The disclosed smart application deployment system and method facilitates one-click, bulk deployment of new software and applications substantially simultaneously. Throughout this disclosure, the terms software, software update, and applications are intended to be non-limiting examples and should be interpreted broadly to encompass any type of digital data capable of providing or enabling features on MFPs and can include executable files, configuration files, graphics, and so forth.

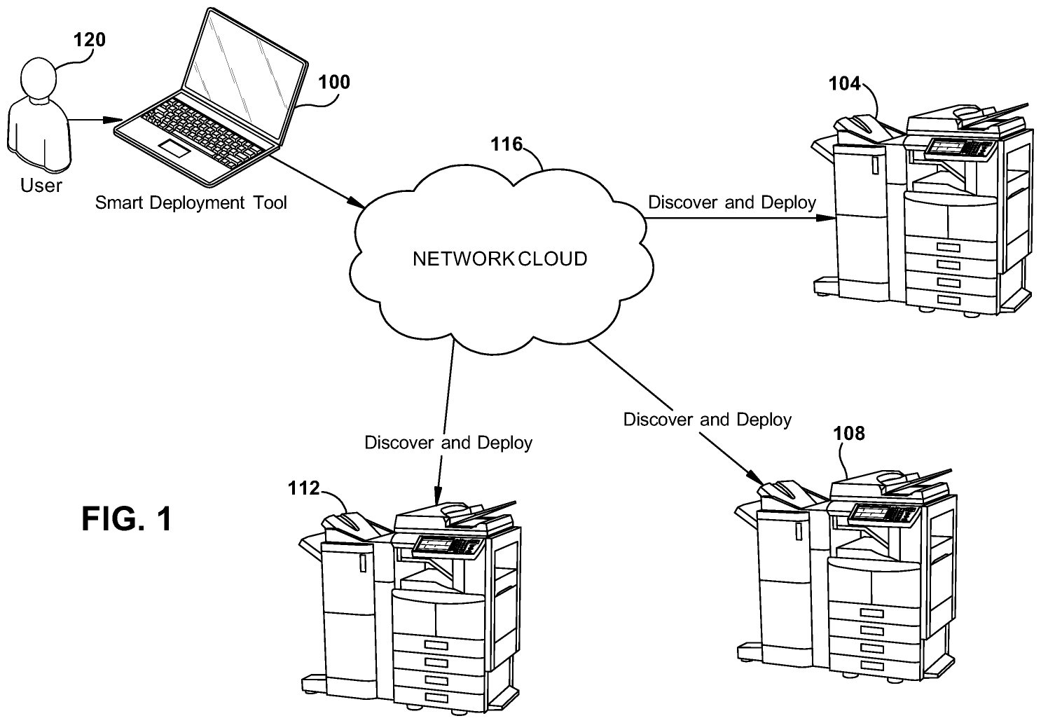

In accordance with the subject application, FIG. 1 illustrates an example embodiment of a system 100 for discovering, and deploying, applications and software to compatible MFPs illustrated by way of example as MFPs 104, 108, and 112. The system 100 is in network communication with MFPs via network cloud 116, suitably comprised of any wireless or wired local area network (LAN) or a wide area network (WAN) which can comprise the Internet, or any suitable combination thereof. A system administrator 120 can control operations of the system 100 via a user interface as described in greater detail below. In certain embodiments, the system administrator 120 can access the user interface of the system 100 over the network cloud 116. The subject example embodiment reflects interaction of the system 100 with MFPs using a laptop, however it will be appreciated that any suitable user device, including a workstation, a smartphone, a cloud based computing platform, or any other suitable computer may be used.

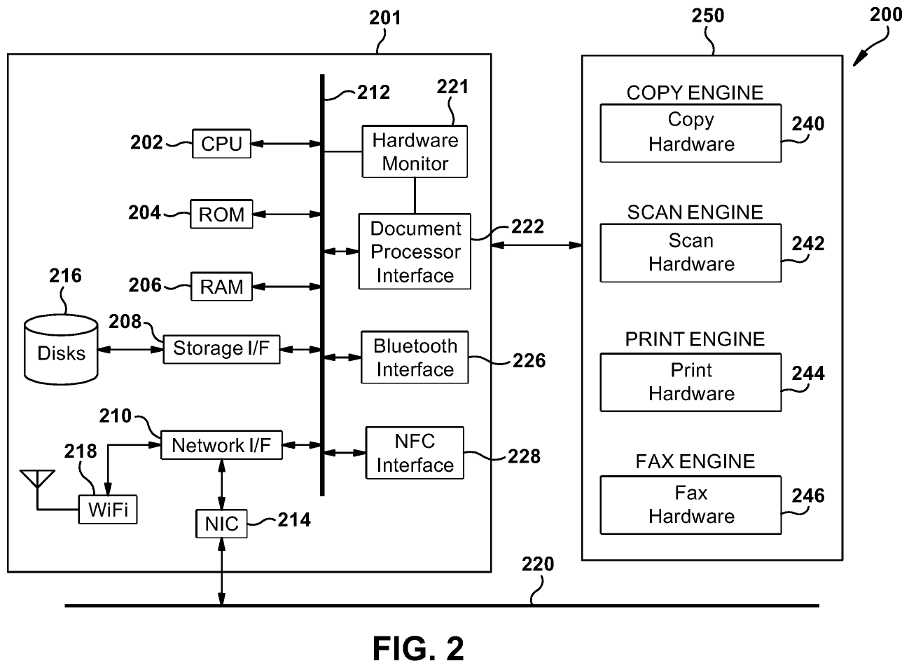

Turning now to FIG. 2 illustrated is an example embodiment of a networked digital device comprised of document rendering system 200 suitably comprised within an MFP, such as with MFPs 104, 108, 112 of FIG. 1. It will be appreciated that an MFP includes an intelligent controller 201 which is itself a computer system. Included in controller 201 are one or more processors, such as that illustrated by processor 202. Each processor is suitably associated with non-volatile memory, such as read only memory (ROM) 204, and random access memory (RAM) 206, via a data bus 212.

Processor 202 is also in data communication with a storage interface 208 for reading or writing data with storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via a wireless network interface, such as WiFi 218. Example wireless connections include cellular, Wi-Fi, wireless universal serial bus (wireless USB), satellite, and the like. Example wired interfaces include Ethernet, USB, IEEE 1394 (FireWire), Lightning, telephone line, or the like. Processor 202 is also in data communication with a hardware monitor 221, suitably amassing state data from subassemblies, sensors, digital thermometers, or the like, and suitably including digital state date including device codes, such as device error codes. Processor 202 can also be in data communication a document processor interface 222, with BLUETOOTH interface 226 and NFC interface 228 via data path 212.

Processor 202 can also be in data communication with any suitable user input/output (I/O) interface (not shown) which provides data communication with user peripherals, such as displays, keyboards, mice, track balls, touch screens, or the like.

Document processor interface 222 is suitable for data communication with MFP functional units 250. In the illustrate example, these units include a copy engine, suitably comprised of copy hardware 240, a scan engine, suitably comprised of scan hardware 242, a print engine, suitably comprised of print hardware 244 and a fax engine, suitably comprised of fax hardware 246. These subsystems together comprise MFP functional hardware 250. It will be understood that functional units are suitably comprised of intelligent units, including any suitable hardware or software platform.

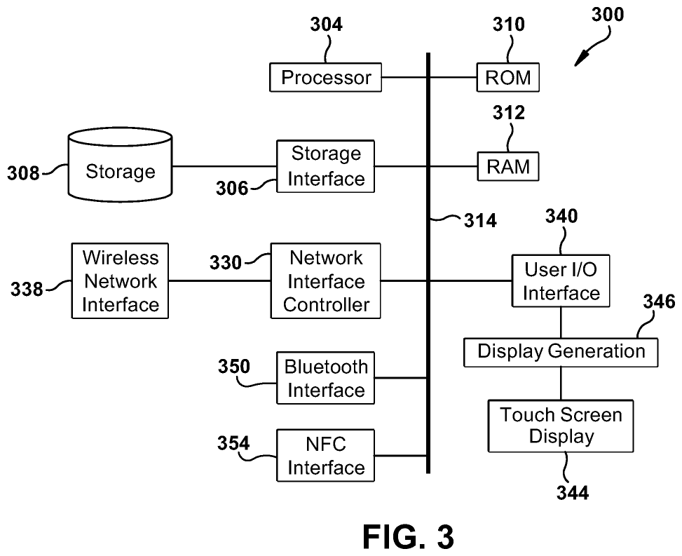

Turning now to FIG. 3, illustrated is an example of a digital device system such as system 100 of FIG. 1. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable network or device connection, such as a suitable wireless data connection via wireless network interface 338. A suitable data connection to an MFP or server is via a data network, such as a local area network (LAN), a wide arear network (WAN), which may comprise the Internet, or any suitable combination thereof. A digital data connection is also suitably directly with an MFP or server, such as via BLUETOOTH, optical data transfer, Wi-Fi direct, or the like.

Processor 304 is also in data communication with a user input/output (I/O) interface 340 which provides data communication with user peripherals, such as touch screen display 344 via display generator 346, as well as keyboards, mice, track balls, touch screens, or the like. Processor 304 is also in data communication with Bluetooth interface 350 and NFC interface 354. It will be understood that functional units are suitably comprised of intelligent units, including any suitable hardware or software platform.

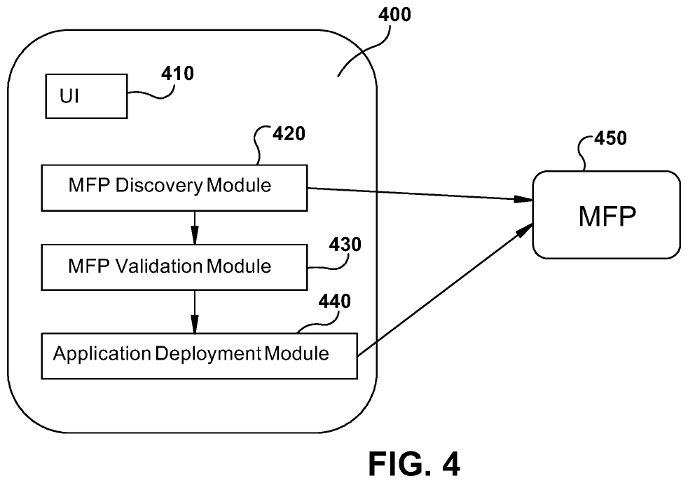

Turning next to FIG. 4, illustrated are example software modules of a system 400 for discovering and deploying software and applications to compatible MFPs represented in FIG. 4 as MFP 250. A user interface software module 410 allows a system administrator to control operations of the system 400. Example operations can include downloading new applications or software for deployment, initiating deployment operations, and configuring settings related to discovery. For example, a system administrator can configure simple network management protocol (SNMP) settings as well as IP ranges or IP subnets to be scanned for discovering compatible MFPs. In smaller networks, such as for small businesses, a company's MFPs may be on a common IP subnet. But in larger networks, as would be typical for larger corporations, MFPs may be on multiple different IP subnets, or can be distributed geographically and may include private networks, multiple ranges of IP addresses, and so forth. The system administrator can manually initiate the discovery and deployment sequences or configure a time for discovery and deployment such as after hours when such operations are less likely to interrupt user's access to the MFPs.

Once discovery and deployment operations are initiated, for example by a system administrator or by a timer, an MFP discovery module 420 performs queries on each of the IP addresses in the IP ranges or IP subnets that were configured by the system administrator. For example, the MFP discovery module 420 can send an SNMP Get call to retrieve software, firmware and/or hardware information from each IP address in the specified networks. If the MFP discovery module 420 does not receive a successful response, such as if the MFP discovery module 420 does not receive any response or receives a response that indicates that the IP address is not associated with an MFP, then the MFP discovery module 420 will continue to scan the other IP address in the specified IP address ranges or subnets. If an IP address is associated with an MFP 450, then the MFP discovery module 420 receives a successful response that includes the requested data about the MFP 450. An MFP validation module 430 can compare the received response or responses with predefined criteria to determine if the MFP 450 has suitable software, firmware, and hardware to execute the new application or software. If the MFP 450 is compatible with the new application or software, then an application deployment module 440 can install the new application or software on the MFP 450 at a suitable time. The application deployment module 440 can be configured by the system administrator via the user interface module 410 to deploy the new application or software immediately, or wait until a designated time to perform the installation, such as after business hours.

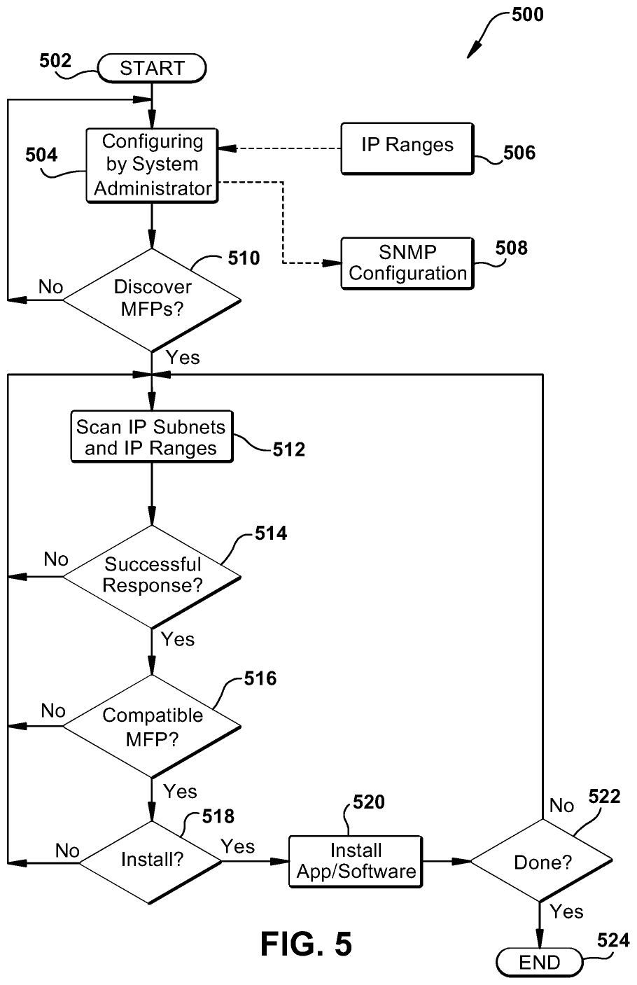

Turning next to FIG. 5, illustrated are example operations 500 of a system for discovering and deploying software and applications to compatible MFPs across a network. Operations commence at start block 502 and proceed to block 504. At block 504, a system administrator can configured the system, for example by entering or editing ranges of IP addresses to be scanned for compatible MFPs or configuring SNMP settings 508. The system administrator determines what new software or new application is to be installed onto compatible MFPs and the then initiates a discovery scan or sets a future time for discovery scanning to commence. Processing continues to block 510.

At block 510, if discovery scanning for compatible MFPs is set to commence then processing continues to block 512, otherwise processing returns to block 504 until the designated time for discovery scanning is initiated by the system administrator or a suitable timer for performing the discovery scanning triggers the scanning.

At block 512, the IP ranges set by the system administrator are scanned for MFPs. For example, the system can initiate an SNMP Get query (or call) to each IP address in the IP range or IP subnet. If a successful response from an MFP is received at block 514, then a check is made to determine if the MFP is compatible with the new software or application at block 516. If the MFP is compatible, then a check is made whether to install the software or wait until a more suitable time at block 518. For example, if the MFP is in the middle of an operation or is currently in use, then processing returns to continue scanning MFPs until a more suitable time. In another example, the installation can be scheduled for after business hours to minimize the possibility of service interruptions to users. If any of the checks for block 514, 516, or 518 are unsuccessful, then processing returns to block 512 to continue scanning for compatible MFPs.

Once the new application or software is ready to be installed on one or more MFPs at block 518, processing continues to block 520 where the new application or software is installed on the MFP or blocks of MFPs. If necessary, MFPs can be restarted to finish the installation process. Processing then continues to block 522.

At block 522, a check is made to determine if the new application or software has finished being installed on compatible MFPs and if scanning for compatible MFPs has finished. If so, then processing terminates at end block 524, otherwise processing returns to block 512 to continue scanning the MFPs and installing the new application or software.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system, comprising:
a memory storing a plurality of internet protocol (IP) addresses and software associated with a multifunction peripheral;
a network interface configured to communicate with the plurality of IP addresses; and
a processor configured to
transmit a query to each of the plurality of IP addresses via the network interface,
receive, from one of the plurality of IP addresses, data associated with a version of a multifunction peripheral associated with the IP address,
validate that the software is compatible with the version of the multifunction peripheral based at least in part on the received data, and
transmit the software to the multifunction peripheral only when the software is compatible.

2. The system of claim 1, wherein the plurality of IP addresses includes an IP subnet.

3. The system of claim 1, wherein the plurality of IP addresses includes a range of IP addresses.

4. The system of claim 1, wherein the query is a simple network management protocol (SNMP) Get.

5. The system of claim 1, wherein the data associated with a version of a multifunction peripheral includes a version selected from the group consisting of a software version, a firmware version, and a hardware version of the multifunction peripheral.

6. The system of claim 1, wherein the processor is further configured to:
schedule a time to transmit the software to the multifunction peripheral, and
wherein the software is transmitted to the multifunction peripheral at the scheduled time.

7. The system of claim 1, wherein the processor is further configured to:
receive, from a plurality of IP addresses, data associated with a version of each of the multifunction peripherals associated with each of the plurality of IP addresses,
validate, for each of the multifunction peripherals, that the software is compatible with the associated version based at least in part on the received data, and
transmit the software only to each validated multifunction peripheral for which the software is compatible.

8. The system of claim 1, further comprising:
a discovery module configured to
transmit the query to each of the plurality of IP addresses via the network interface, and
receive the data associated with the version of the multifunction peripheral;
a validation module configured to validate that the software is compatible with the version of the multifunction peripheral; and
a deployment module configured to transmit the software to the multifunction peripheral.

9. A method comprising:
storing, in a memory, a plurality of internet protocol (IP) addresses and software associated with a multifunction peripheral;
transmitting a query to each of the plurality of IP addresses via an associated network interface;
receiving, via the network interface from one of the plurality of IP addresses, data associated with a version of a multifunction peripheral associated with the IP address;
validating, by an associated processor, that the software is compatible with the version of the multifunction peripheral based at least in part on the received data;
transmitting, via network interface by the processor, the software to the multifunction peripheral only when the software is compatible.

10. The method of claim 9, further comprising:
scheduling a time to transmit the software to the multifunction peripheral, and
wherein the software is transmitted to the multifunction peripheral at the scheduled time.

11. The method of claim 9, further comprising:
receiving, via the network interface from a plurality of IP addresses, data associated with a version of each of the multifunction peripherals associated with each of the plurality of IP addresses;
validating, by the processor for each of the multifunction peripherals, that the software is compatible with the associated version based at least in part on the received data; and
transmitting, by the processor via the network interface, the software only to each validated multifunction peripheral for which the software is compatible.

12. The method of claim 9, wherein the data associated with a version of a multifunction peripheral includes a version selected from the group consisting of a software version, a firmware version, and a hardware version of the multifunction peripheral.

13. The method of claim 9, wherein transmitting the query and receiving the data are performed by an associated discovery module,
wherein validating that the software is compatible is performed by an associated validation module, and
wherein transmitting the software to the multifunction peripheral is performed by an associated a deployment module.

14. The method of claim 9, wherein the plurality of IP addresses includes an IP subnet.

15. The method of claim 9, wherein the plurality of IP addresses includes a range of IP addresses.

16. The method of claim 9, wherein the query is a simple network management protocol (SNMP) Get.

17. A system, comprising:
a memory storing internet protocol (IP) addresses, simple network management protocol (SNMP) configuration data, and a software update for a multifunction peripheral; and
a user interface configured to accept an input from a system administrator of one or more of
at least one of the IP addresses, or
SNMP configuration data; and
a processor configured to
transmit, to each of the IP addresses, an SNMP Get query based at least in part on the SNMP configuration data,
receive, in response to the SNMP Get query, version data from at least one multifunction peripheral associated with at least one of the IP addresses,
validate, for each response from a multifunction peripheral, that the software update is compatible with the multifunction peripheral based on the version data, and
transmit the software to the multifunction peripheral only if the software update is compatible.

18. The system of claim 17, wherein the processor is further configured to:
schedule a time to transmit the software to the multifunction peripheral, and
wherein the software is transmitted to the multifunction peripheral at the scheduled time.

19. The system of claim 17, wherein the version data includes a version selected from the group consisting of a software version, a firmware version, and a hardware version of the multifunction peripheral.

20. The system of claim 17, further comprising:
a discovery module configured to
transmit the SNMP Get query to each of the IP addresses, and
receive version data from one or more multifunction peripherals;
a validation module configured to validate that the software update is compatible with the one or more multifunction peripherals based on the version data; and
a deployment module configured to transmit the software update to compatible multifunction peripherals.
